(19) United States
(12) Patent Application Publication
(10) Pub. No.: US 2025/0336124 A1
(43) Pub. Date: Oct. 30, 2025

(54) METHOD FOR END-CLOUD COLLABORATION-BASED IMAGE PROCESSING, APPARATUS, DEVICE AND STORAGE MEDIUM

(71) Applicant: Lemon Inc., Grand Cayman (KY)

(72) Inventors: Chun Liu, Beijing (CN); Qingyu Chen, Los Angeles, CA (US)

(21) Appl. No.: 18/853,111

(22) PCT Filed: Mar. 8, 2023
(86) PCT No.: PCT/SG2023/050145

§ 371 Date: Sep. 30, 2024

(30) Foreign Application Priority Data
Mar. 31, 2022 (CN) 202210346024.7

(51) Int. Cl. G06T 11/60; G06F 3/04845; G06T 5/50

(52) U.S. Cl. CPC G06T 11/60; G06F 3/04845; G06T 5/50; G06T 2207/20221

(57) ABSTRACT

Embodiments of the disclosure provide a solution for end-cloud collaboration-based image processing. A method includes: in response to a first operation instruction, displaying a first preview image, wherein the first preview image is an image obtained by adding a first visual effect with a first precision to an original image, and the first visual effect with the first precision is obtained based on a first local algorithm model run at the terminal device; sending an algorithm invoking request to a server based on the first operation instruction; in response to a second operation instruction, generating a target image based on a rendered image responded by the server to an algorithm invoking request, wherein the rendered image is an image obtained by adding a first visual effect with the second precision to the original image, and the target image is an image used for displaying on the terminal device.

### CROSS REFERENCE OF RELATED APPLICATION(S)

This disclosure is the U.S. National Stage of International Application No. PCT/SG2023/050145, filed on Mar. 8, 2023, which claims priority to Chinese Patent Application No. 202210346024.7. filed with the Chinese Patent Office on March 31. 2022. and entitled “METHOD FOR END-CLOUD COLLABORATION-BASED IMAGE PROCESSING, APPARATUS. DEVICE AND STORAGE MEDIUM”, which is incorporated herein by reference in its entirety.

### FIELD

Embodiments of the present disclosure relate to a field of image processing technologies, and in particular. to a method for end-cloud collaboration-based image processing, apparatus, an electronic device, a storage medium. a computer program product, and a computer program.

### BACKGROUND

At present, in an application (Application. APP) such as a short video type and a social media type, for image data such as a picture and a video uploaded by a user, the application can provide an effective rendering capability for the image data, and add a visual effect to the image data, for example, add a virtual decoration and a filter to the video and the image, thereby enriching functions and play of the application

In the prior art, in a process of performing effect rendering on the image data, with regard to some complex effect rendering, limited by a hardware capability of a terminal device, a model and an algorithm for implementing the effect rendering are usually arranged at a server side, and are executed based on a request of an application, and then an effect rendering result is sent back to the terminal device for display or further processing.

However, in the solution in the prior art, since an algorithm for implementing effect rendering is executed at the server side, during execution of an image rendering process on a terminal device side, a jam may occur or a page is forcibly waiting, which affects fluency and efficiency of the terminal device executing effect rendering process.

### SUMMARY

Embodiments of the present disclosure provide a method for end-cloud collaboration-based image processing and apparatus, an electronic device, a storage medium, a computer program product, and a computer program, to overcome problems of being stuck or presenting a forced waiting page in the prior art.

According to a first aspect, embodiments of the present disclosure provide a method for end-cloud collaboration-based image processing, which is applied to a terminal device and includes:
in response to a first operation instruction, displaying a first preview image, wherein the first preview image is an image obtained by adding a first visual effect with a first precision to an original image, and the first visual effect with the first precision is obtained based on a first local algorithm model run at the terminal device: sending an algorithm invoking request to a server based on the first operation instruction, wherein the algorithm invoking request is used for invoking a first remote algorithm model executed at the server to add a first visual effect with a second precision to the original image, and wherein the second precision is greater than the first precision: in response to a second operation instruction, generating a target image based on a rendered image responded by the server to the algorithm invoking request, wherein the rendered image is an image obtained by adding the first visual effect with the second precision to the original image, and the target image is an image used for display on the terminal device.

According to a second aspect, embodiments of the present disclosure provide an apparatus for end-cloud collaboration-based image processing, including:
a display module configured to display: in response to a first operation instruction, a first preview image. wherein the first preview image is an image obtained by adding a first visual effect with a first precision to an original image, and the first visual effect with the first precision is obtained based on a first local algorithm model run at the terminal device:
an invoking module configured to send an algorithm invoking request to a server based on the first operation instruction, wherein the algorithm invoking request is used for invoking a first remote algorithm model executed at the server to add a first visual effect with a second precision to the original image, and wherein the second precision is greater than the first precision:
a generation module configured to generate, in response to a second operation instruction, a target image based on a rendered image responded by the server to the algorithm invoking request, wherein the rendered image is an image, obtained by adding the first visual effect with a second precision to the original image, and the target image is an image used for displaying on the terminal device.

According to a third aspect, embodiments of the present disclosure provide an electronic device, including:
a processor and a memory communicatively coupled with the processor:
the memory stores computer execution instructions:
the computer execution instructions stored in the memory are executed by the processor, to implement the method for end-cloud collaboration-based image processing according to the first aspect.

According to a fourth aspect, embodiments of the present disclosure provide a computer readable storage medium has computer execution instructions stored therein which, when executed by a processor, implement the method for end-cloud collaboration-based image processing according to the first aspect.

According to a fifth aspect, embodiments of the present disclosure provide a computer program product. including a computer program which, when executed by a processor, implements the method for end-cloud collaboration-based image processing according to the first aspect.

According to a sixth aspect, embodiments of the present disclosure further provide a computer program which. when executed by a processor, implements the method for end-cloud collaboration-based image processing according to the first aspect.

### BRIEF DESCRIPTION OF THE DRAWINGS

To describe technical solutions in embodiments of the present disclosure or in the prior art more clearly. following briefly introduces drawings required for describing the embodiments or the prior art. Apparently, the drawings in following description show some embodiments of the present disclosure, other drawings may also be obtained based on these drawings without creative efforts.

FIG. 1 is a schematic process diagram of adding a visual effect to an image in the prior art:

FIG. 2 is a first schematic flowchart of a method for end-cloud collaboration-based image processing provided by embodiments of the present disclosure:

FIG. 3 is a flowchart of specific implementation steps of a possible implementation manner of step S101:

FIG. 4 is a schematic diagram of a first preview image provided by embodiments of the present disclosure:

FIG. 5 is a flowchart of specific implementation steps of a possible implementation manner of step S102:

FIG. 6 is a second flowchart of a method for end-cloud collaboration-based image processing provided by embodiments of the present disclosure:

FIG. 7 is a schematic process diagram of adding a visual effect to an image provided by embodiments of the present disclosure:

FIG. 8 is a flowchart of specific implementation steps of a possible implementation manner of step S203:

FIG. 9 is a flowchart of specific implementation steps of a possible implementation manner of step S204:

FIG. 10 is a flowchart of specific implementation steps of another possible implementation manner of step S204:

FIG. 11 is a schematic process diagram of generating a target image provided by embodiments of the present disclosure:

FIG. 12 is a structural block diagram of an apparatus for end-cloud collaboration-based image processing provided by embodiments of the present disclosure:

FIG. 13 is a schematic structural diagram of an electronic device provided by embodiments of the present disclosure:

FIG. 14 is a schematic structural diagram of hardware of an electronic device provided by embodiments of the present disclosure.

### DETAILED DESCRIPTION

In order to make objects, technical solutions and advantages of embodiments of the present disclosure more apparent, the technical solutions in the embodiments of the present disclosure will be described below in a clearly and fully understandable way in connection with drawings related to the embodiments of the present disclosure. Obviously, described embodiments are only a part but not all of the embodiments of the present disclosure. All other embodiments obtained by those ordinary skilled in the art based on the embodiments of the present disclosure without creative efforts shall belong to a scope of protection of the present disclosure.

Application scenarios of the embodiments of the present disclosure will be explained below:

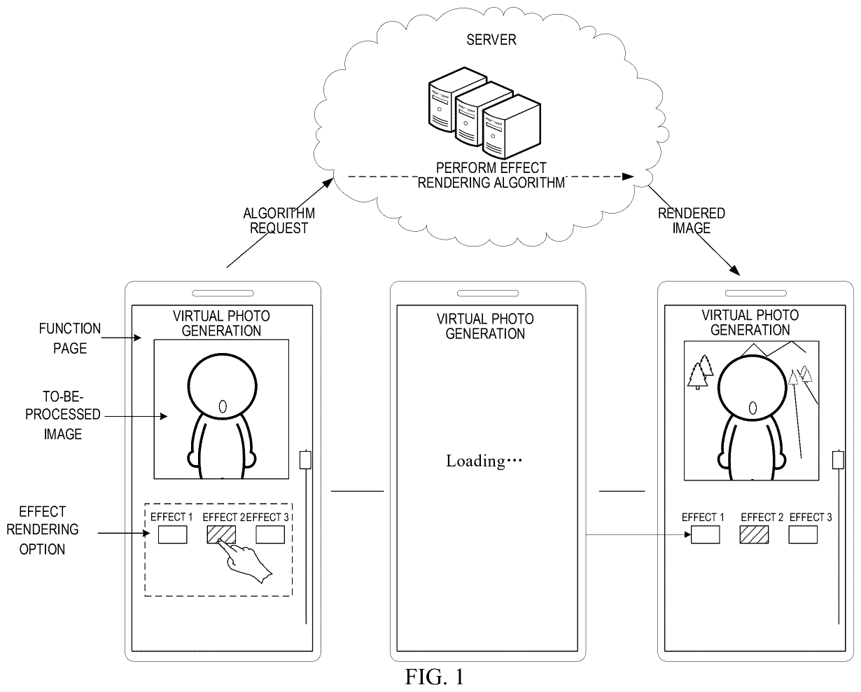

A method for end-cloud collaboration-based image processing provided by the embodiments of the present disclosure can be applied to an application scenario of performing image effect rendering based on end-cloud coordination. Specifically, the method provided by the embodiment of the present disclosure can be applied to a terminal device, such as a smart phone, a tablet computer and the like. Applications such as a short video type and a social media type (hereinafter referred to as target application) run in the terminal device. FIG. 1 is a schematic process diagram of adding a visual effect to an image in the prior art, as shown in FIG. 1, in the ‘virtual photo generation’ function page of the target application, after a user selects a to-be-processed image (including a video or a picture), the target application provides several effect rendering options (shown as effect 1, effect 2, effect 3. etc.) for the user, after specific effect information (for example, comprising an effect type, an effect parameter, etc.) is determined through an effect rendering option, the terminal device sends an algorithm request containing above-described effect information and a to-be-processed image to a corresponding server. The server responds to the algorithm request, executes a corresponding effect rendering algorithm at a server side, and responds generated rendering data to a terminal device side to perform display: and generates a rendered image with added visual effects.

At present, for some complex effects, in order to realize a better rendering effect, algorithms and models for implementing the complex effects are generally set to be executed on the server side, for example, an image style transition effect, an AR target identification effect, and the like. However, as shown in FIG. 1, since a process of processing the to-be-processed image by invoking a remote algorithm model on the server side by the terminal device is executed asynchronously relative to a process of performing a local algorithm model, before the server responds no data, a target application client on the terminal device side may be in a state of being stuck or a state of being forced to display a waiting page (in drawing, it is shown that a “Loading” page is forcefully displayed). The user can only wait, which affects fluency and efficiency of an effect rendering process.

Embodiments of the present disclosure provide a method for end-cloud collaboration-based image processing to solve above-described problem.

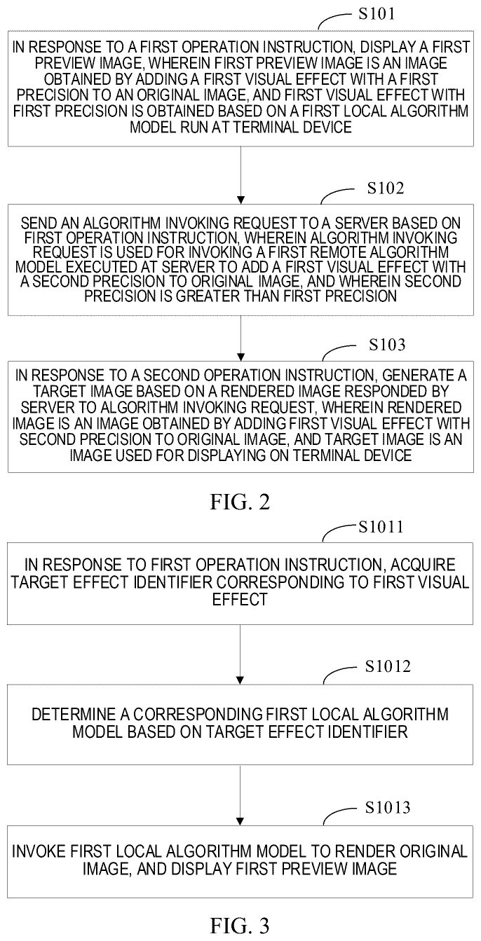

Referring to FIG. 2. FIG. 2 is a first schematic flowchart of a method for end-cloud collaboration-based image processing provided by embodiments of the present disclosure. The method in this embodiment may be applied to a terminal device. The method for end-cloud collaboration-based image processing includes:

step S101: in response to a first operation instruction, displaying a first preview image, wherein the first preview image is an image obtained by adding a first visual effect with a first precision to an original image, and the first visual effect with the first precision is obtained based on a first local algorithm model run at a terminal device.

As an example, the original image may be a picture or a video determined based on a user operation instruction. In this embodiment, a picture is taken as an example for description. Specifically, for example, based on a user instruction, a photo is selected from an album page of a terminal device and used as the original image, or a photo is directly photographed by using a camera unit and used as the original image.

More specifically, as an example, before step S101, the method further includes: loading and displaying an image effect tool in a target application: in response to a tool operation instruction on the image effect tool, displaying an image acquisition interface, for acquiring an original image. The image effect tool is a tool script for realizing effect rendering, and is displayed in an identifier of a specific style, such as a “tool” icon, in a target application client. When a user performs an operation on the image effect tool, for example, clicking. the terminal device receives a tool operation instruction on the image effect tool and triggers a corresponding execution script to display an image acquisition interface, wherein the image acquisition interface is, for example. a camera interface or an album interface, and then an original image is obtained based on a further operation of the user. Through above-described steps, a purpose of triggering an image effect tool and acquiring an original image is achieved, so that in a subsequent step, effect rendering can be performed based on acquired original image.

After the original image is selected based on the tool operation instruction, the original image will be loaded and displayed (refer to the to-be-processed image shown in FIG. 1) in the current functional page of the target application (for example, the functional page “virtual photo generation” shown in FIG. 1). Meanwhile, as an example, there are also several effect rendering options for the user to select in the current function page, and by selecting a specific effect rendering option, the purpose of adding a corresponding visual effect to the original image can be obtained.

Further, in above-described current function page, the terminal device receives a first operation instruction to an effect rendering option corresponding to the first visual effect, responds thereto, and generates and displays the first preview image. Specifically, after receiving the first operation instruction, the terminal device invokes. based on the first visual effect indicated by the first operation instruction, a corresponding first local algorithm model to process the original image, to obtain the first preview image. The first local algorithm model can add a first visual effect with a first precision to an image. More specifically, the first precision corresponds to low precision. The first local algorithm model is a light-weight model suitable for execution of a terminal device, for example, a light-weight image style migration model, the first local algorithm model may perform low-precision rendering on an image, so that a feature with a first precision (low precision) is added to the image.

Further, in this embodiment, low-precision rendering obtained by the first local algorithm model has different implementation manners to a specific algorithm, for example, to an algorithm model for adding a virtual map to an image, low precision may refer to a generated virtual map has a relatively low resolution: for another example, for an algorithm model for performing image style conversion on an image, low precision may also refer to an image generated after the style conversion has relatively low accuracy. Due to a light-weight feature of the first local algorithm model, it is possible to rapidly perform and complete a process of specifically rendering an image and generating a first preview image on the terminal device side, thereby realizing a rapid display of the first preview image.

In a possible implementation, the first remote algorithm model is an image style transfer model based on a generative antagonistic network (GAN network): the first local algorithm model is a light-weight model obtained by model distillation of the first remote algorithm model.

As an example. FIG. 3 is a flowchart of a specific implementation of a possible implementation of step S101. and as shown in FIG. 3, step S101 includes:

Step S1011: In response to the first operation instruction, acquiring a target effect identifier corresponding to the first visual effect.

Step S1012: determining a corresponding first local algorithm model based on the target effect identifier.

Step S1013: invoking a first local algorithm model to render an original image, and displaying the first preview image.

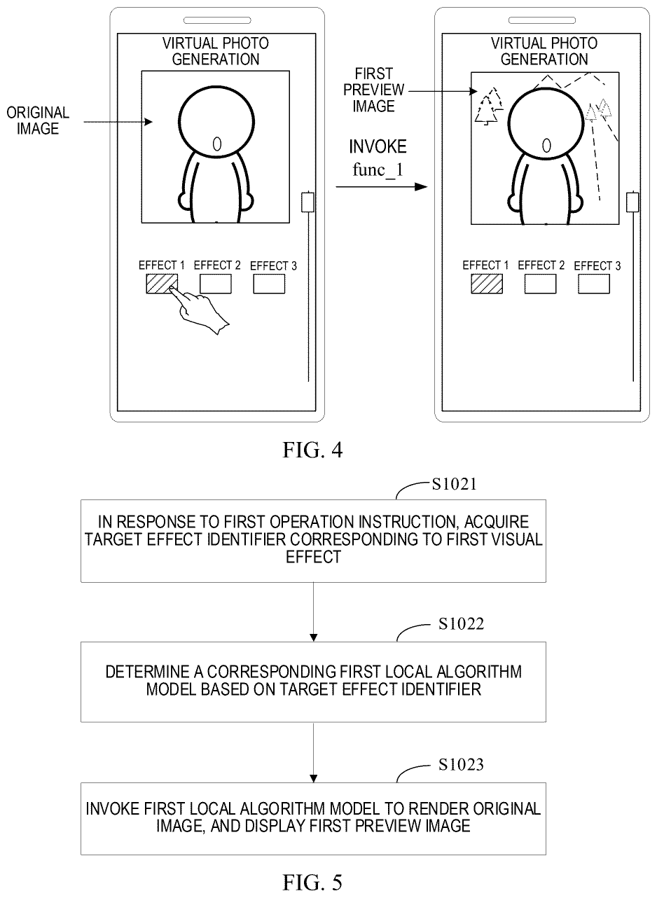

FIG. 4 is a schematic diagram of the first preview image provided by embodiments of the present disclosure. and as shown in FIG. 4, as an example, within a functional page of a target application, after loading and displaying an original image, after a terminal device receives a first operation instruction (an instruction corresponding to a click operation being shown in the drawing) for a target effect identifier (being shown as “effect 1”), a first local algorithm model (shown as func_1 in the drawing) corresponding to the target effect identifier is determined, and specifically: the first local algorithm model may be implemented in a form of a function, invoking a function corresponding to a first local algorithm model to add a first visual effect with low accuracy to the original image. and displaying a first preview image in an overlay manner at a display position of the original image.

Step S102: sending an algorithm invoking request to a server based on the first operation instruction, wherein the algorithm invoking request is used for invoking a first remote algorithm model executed at the server to add a first visual effect with a second precision to the original image.

As an example, on the other hand, after or at the same time when the terminal device receives the first operation instruction and makes a response, an algorithm invoking request is sent to the server, wherein as an example, the algorithm invoking request may include the original image and identification information about the first visual effect corresponding to the target effect rendering option indicated by the first operation instruction. After receiving the algorithm invoking request, the server invokes, based on the original image and the identification information about the first visual effect in the algorithm invoking request, a first remote algorithm model corresponding to the first visual effect, processes the original image, and generates a rendered image. The second precision corresponds to a high precision. The first remote algorithm model may be a complex large neural network model suitable for the operation of a server, for example, an image style transfer model based on a deep neural network. The first remote algorithm model may render an image with a high precision, to add a feature of the second precision (high precision) to the image.

In this embodiment, for rendering precision (namely: first precision and second precision) achieved by a first local algorithm model and a first remote algorithm model, there are different implementations for a specific visual effect algorithm model, for example, for an algorithm model for adding a virtual map to an image, the precision may refer to resolution of a generated virtual map: For another example, for an algorithm model for performing image style conversion on an image, accuracy may also refer to accuracy of an image generated after the style conversion, and a specific meaning of the accuracy is not limited herein.

As an example. FIG. 5 is a flowchart of specific implementation steps of a possible implementation manner of step S102. As shown in FIG. 5, step S102 includes:

Step 1021: generating, based on the first operation command and the original image, an algorithm request parameter corresponding to the first remote algorithm model.

Step S1022: sending the algorithm invoking request to a server based on the algorithm request parameter.

Step S1023: receiving the rendered image responded by the server to the algorithm invoking request, and buffering the rendered image.

As an example, the first operation instruction may include identification information of the first visual effect corresponding to the target effect rendering option. More specifically, the identification information includes, for example, a type identifier characterizing an effect type of the first visual effect, and a parameter identifier of a type parameter corresponding to the feature type identifier, generating, according to the identification information and the original image construction algorithm request parameter, an input parameter that can be identified by the first remote algorithm model. In addition, an algorithm request parameter is sent to a server, to realize remote invoking on a first remote algorithm model: and after executing the first remote algorithm model, the server generates a rendered image, responds the rendered image to a terminal device, and buffers the same at a side of the terminal device for future use. In the subsequent steps, when responding to the second operation instruction, the buffered rendered image may be directly used to generate the target image, without the need of sending an invocation request to the server again.

Step S103: in response to a second operation instruction, generating a target image based on the rendered image responded by the server to the algorithm invoking request, wherein the rendered image is an image obtained by adding a first visual effect with the second precision to the original image, and the target image is an image used for displaying on a terminal device.

As an example, after the first preview image is displayed in response to the first operation instruction, the original image is sent to the server for processing synchronously (namely, step S102). The user then views the first preview image to determine the effect with adding the first visual effect on the original image. If the user determines to use the first visual effect, a second operation instruction is input, where the second operation instruction is, for example, clicking a ‘start rendering’ control (not shown in the drawing) on the current functional page. After that. the terminal device acquires the buffered rendered image, post-processes the rendered image based on a local algorithm (for example, denoising, clipping, upsampling), and then generates a target image for display, or directly displays the rendered image as the target image. In a possible implementation manner, because a rendered image has been buffered in a terminal device, the terminal device may directly read the rendered image based on a request of a target application to generate the target image, which consumes little time: therefore, no lags and forced waiting pages in the prior art as shown in FIG. 1 occur. However, in another possible implementation manner, when the user inputs the second operation instruction, the server does not respond the rendered image. In this case, it is still necessary to wait for a response from the server by displaying a compulsory waiting page. Thus, compared with the prior art, the time for displaying the compulsory waiting page can still be effectively shortened. Thus, the fluency of the effect rendering process is improved.

In this embodiment, in response to a first operation instruction, a first preview image is displayed, where the first preview image is an original image to which a first visual effect with a first precision is added, and the first visual effect with the first precision is implemented based on a first local algorithm model run at a terminal device: sending an algorithm invoking request to a server based on a first operation instruction, wherein the algorithm invoking request is used for invoking a first remote algorithm model executed at the server to add a first visual effect with a second precision to an original image: in response to a second operation instruction, generating a target image according to a rendered image responded by a server to an algorithm invoking request, wherein the rendered image is an image obtained after adding a first visual effect with a second precision to an original image, and the target image is an image used for displaying on a terminal device, generating a first preview image of a first visual effect with a first precision (low precision) by executing a first local algorithm locally, and displaying same can achieve the purpose of showing a rendering effect for a user in advance, and at the same time, synchronously sending an original image to a server to execute a corresponding first remote algorithm model, generating a rendered image to which a first visual effect with a second precision (high precision) is added, and when a user determines to use the first visual effect to render an original image. When the second operation instruction is input, the effect rendering process is actually executed at the server side. Therefore, a rendered image responded by the server may be obtained more quickly, and a target image for final display is generated based on the rendered image, avoiding the occurrence of being stuck and forced waiting page, or reducing duration of being stuck and forced waiting page, and improving fluency and efficiency of the terminal device executing an effect rendering process.

Referring to FIG. 6. FIG. 6 is a second flowchart of a method for end-cloud collaboration-based image processing according to an embodiment of the present disclosure. On the basis of the embodiment shown in FIG. 2. this embodiment further adds a step of adding a second visual effect to an original image. A method for end-cloud collaboration-based image processing provided in an embodiment of the present disclosure is applicable to an application scenario of multi-effect overlay rendering of an image. The application scenario is described below first.

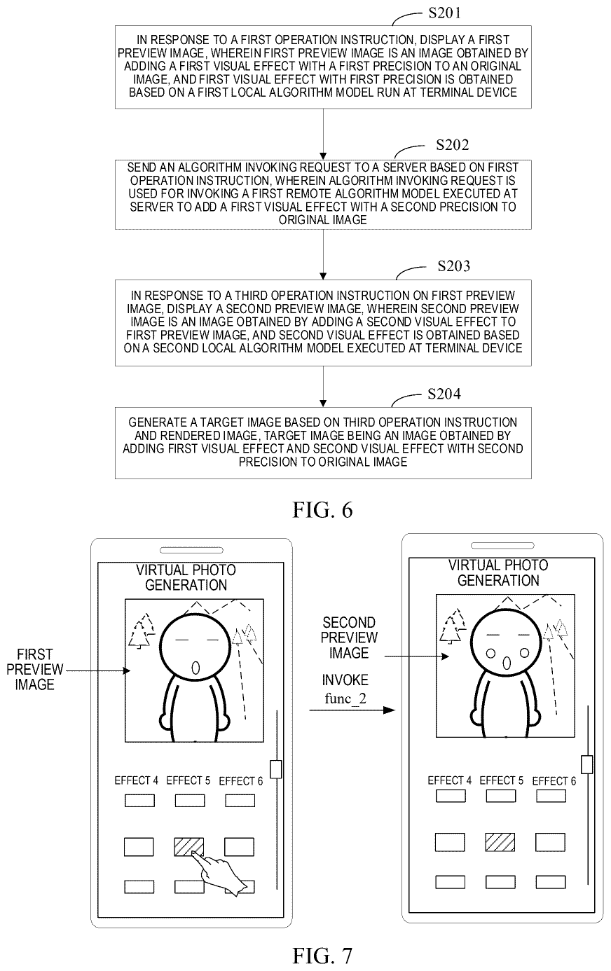

FIG. 7 is a schematic diagram of a process of adding a visual effect to an image according to an embodiment of the present disclosure, after the first preview image is displayed based on the first operation instruction, an effect rendering option (shown as effect 4, effect 5, effect 6, etc.) arranged in the functional page is used. Based on a third operation instruction (which is shown as an instruction corresponding to a click operation in the drawing), on the basis of the first preview image. The second visual effect is further augmented by invoking the locally executed second local algorithm model (func_2). Thus, a multi-effect stacking effect is formed. As shown in FIG. 7, by clicking ‘effect 5’, on the basis of the first preview image, a ‘blush’ effect is added to the human face in the first preview image.

The method for end-cloud collaboration-based image processing provided in the embodiments of the present disclosure is used for solving the problem of jamming or forced waiting for a page in the described application scenario. Specifically, the embodiments of the present disclosure provide a method for end-cloud collaboration-based image processing based on End-Cloud coordination, comprising:

Step S201: in response to a first operation instruction, displaying a first preview image, wherein the first preview image is an original image to which a first visual effect with a first precision is added, and the first visual effect with the first precision is implemented based on a first local algorithm model run at a terminal device.

Step S202: sending the algorithm invoking request to a server based on the first operation instruction, wherein the algorithm invoking request is used for invoking a first remote algorithm model executed at the server to add a first visual effect with a second precision to an original image.

As an example, the second precision is greater than the first precision. After responding to the first operation instruction, the terminal device sends an algorithm invoking request to the server at the same time. In order to ensure that the sending of the algorithm invoking request is executed synchronously with the display of the second preview image, the described two processes are processed through different processes. Specifically, for example, an algorithm invoking request corresponding to the first operation instruction is sent to the server through the second process, a step of processing and displaying the second preview image through the first course.

Step S203: in response to a third operation instruction on the first preview image, displaying a second preview image, wherein the second preview image is an image obtained by adding a second visual effect to the first preview image, and the second visual effect is obtained based on a second local algorithm model executed at the terminal device.

As an example, referring to a schematic diagram of a process shown in FIG. 7, after receiving and responding to a third operation instruction for a first preview image, a second visual effect is added on the basis of the first preview image, to generate and display a second preview image. The second local algorithm model for implementing the second visual effect is executed on the terminal device, that is, implemented by using a low-complexity local algorithm, and therefore may be completed immediately.

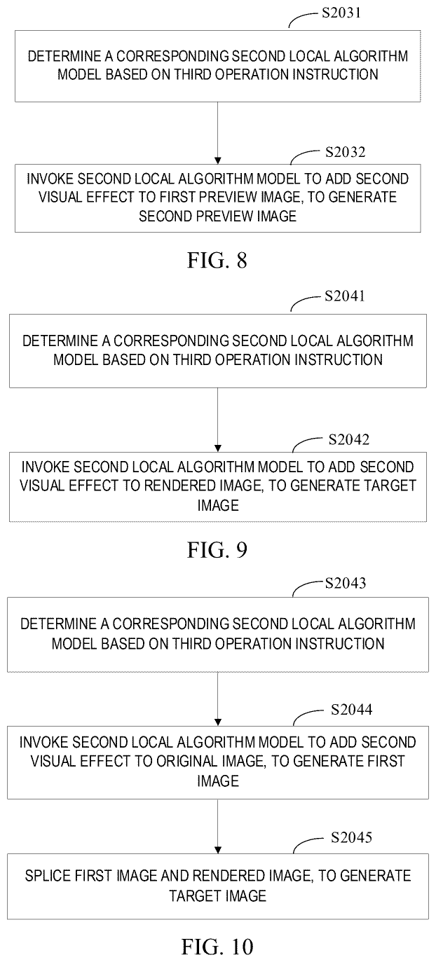

As an example. FIG. 8 is a flowchart of specific implementation steps of a possible implementation manner of step S203, and as shown in FIG. 8, step S203 includes:

Step S2031: determining a corresponding second local algorithm model based on the third operation instruction.

Step S2032: invoking the second local algorithm model to add the second visual effect to the first preview image, a to generate the second preview image.

As an example, the third operation instruction includes an effect identifier and an effect parameter corresponding to the second visual effect, and the effect identifier and the effect parameter together determine an effect with the second visual effect. In response to a third operation instruction for a first preview image, displaying a second preview image specifically includes: invoking, through a second process, a second local algorithm model corresponding to an effect identifier, rendering the first preview image based on the effect parameter, and displaying the second preview image. In the steps of this embodiment, the second visual effect is a relatively simple effect compared with the first visual effect, for example, adding a virtual object to an image, adjusting an image hue, and so on, and therefore, may be implemented on a terminal device side by invoking a second local algorithm model. Meanwhile, in a process in which the user inputs and processes the third operation instruction, an algorithm invoking request for realizing the first time effect is sent to the server, which is equivalent to that the terminal device and the server synchronously perform image rendering instead of a serial processing manner in the prior art, thereby improving the image rendering efficiency.

Step S204: generating a target image based on the third operation instruction and the rendered image, the target image being an image obtained by adding the first visual effect and the second visual effect with the second precision to the original image.

As an example, after receiving a third operation instruction, a corresponding second visual effect may be determined based on the third operation instruction: and after a user confirms an effect rendering effect through a second preview image, a terminal device generates a target image after a first visual effect and a second visual effect that include second precision through fusing the second visual effect and the rendered image. The process may be processed by a fourth operation instruction input by the user, more specifically, for example, clicking a ‘start rendering’ control.

As an example. FIG. 9 is a flowchart of a specific implementation of a possible implementation of step S204. As shown in FIG. 9, step S204 includes:

Step S2041: determining a corresponding second local algorithm model based on the third operation instruction.

Step S2042: invoking the second local algorithm model to add the second visual effect to the rendered image. to generate the target image.

As an example, in a possible implementation manner, the first visual effect and the second visual effect are serial superimposition, that is, after the rendered image is obtained, the second visual effect needs to be further added to the rendered image, to generate the target image. In a possible implementation, the third operation instruction includes an effect identifier and an effect parameter corresponding to the second visual effect, wherein the effect identifier and the effect parameter together determine a specific implementation of the second data effect. and further, the effect parameter includes an effect location, i, e, a rendering location of the second visual effect. This implementation is specifically used in a case where the second visual effect is adding a map to an image. Determining a corresponding second local algorithm model according to a third operation instruction, comprising:

determining a corresponding target local algorithm model according to an effect identifier, wherein the target local algorithm model is used for adding a target effect corresponding to the effect identifier to an image, invoking a second local algorithm model, adding a second visual effect to a rendered image, and generating a target image. The method includes: based on a target local algorithm model, adding a target effect at an effect position. In this embodiment, when serial superimposition is performed on a first visual effect and a second visual effect, the second visual effect is set at an effect position, thereby implementing a serial superimposition effect and improving visual performance of an image.

As an example. FIG. 10 is a flowchart of specific implementation steps of another possible implementation manner of step S204. As shown in FIG. 10, step S204 includes:

Step S2043: determining a corresponding second local algorithm model based on the third operation instruction.

Step S2044: invoking the second local algorithm model to add a second visual effect to the original image to generate a first image.

Step S2045: splicing the first image and the rendered image to generate the target image.

As an example, in another possible case, the first visual effect and the second visual effect are superimposed in parallel, that is, the first visual effect and the second visual effect in the rendered image do not affect each other: therefore, the original image may be directly rendered by using a second local algorithm model corresponding to the second visual effect, to obtain the first image, and then the first image and the rendered image are spliced to obtain the target image.

As an example, the specific steps of splicing a first image and a rendered image to generate a target image include: acquiring a first effect region and a second effect region, wherein the first effect region is an image region where a second visual effect is located in the first image, and the second effect region is an image region where a first visual effect is located in the rendered image: Based on the first effect zone and the second effect region, the first image and the rendered image are spliced to generate a target image.

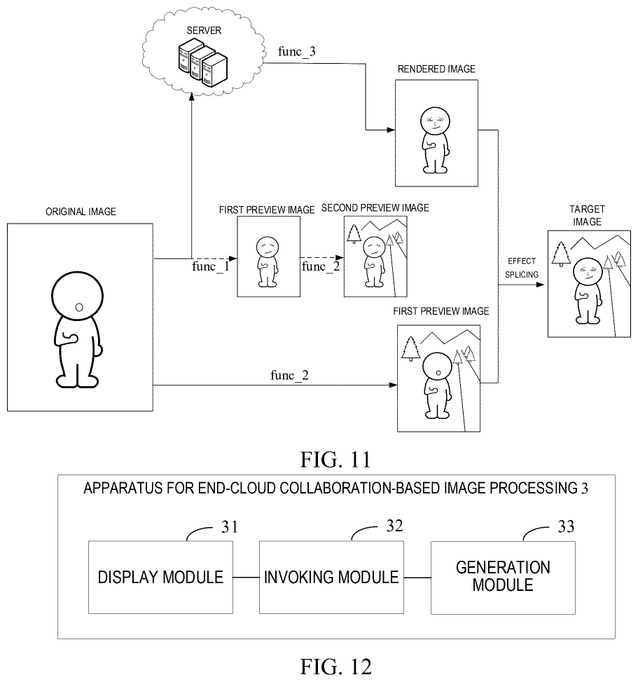

FIG. 11 is a schematic diagram of a process of generating a target image according to an embodiment of the present disclosure. Based on the original image, adding a first visual effect and a second visual effect to the original image respectively, and generating a corresponding first image and a corresponding rendered image (second precision), namely, high precision), and then based on a first effect region corresponding to the first image and a second effect region corresponding to the rendered image, performing effect splicing to obtain a target image. wherein the first image is generated by invoking a local algorithm model func_2, the rendered image is generated by a remote algorithm model func_3 running at a server side, in the process, the first preview image (first precision. i, e, low precision) is generated based on an original image through the local algorithm model func_1, and the second preview image is generated by invoking the local algorithm model func_2 on the basis of the first preview image.

In this embodiment, an original image is synchronously rendered and spliced, so that synchronous rendering of a first visual effect and a second visual effect may be implemented, thereby further improving the effect rendering efficiency, and rapidly generating a target image containing the first visual effect and the second visual effect with a second precision (high precision). Furthermore, in the two methods (parallel and serial) for generating a target image shown in FIGS. 9 and 10. Regardless of the implementation, after responding to the first operation instruction (displaying the first preview image), the algorithm invocation request is sent to the server immediately. During the execution of the third operation instruction, the process of buffering the rendered image on the terminal device side is completed, at the same time, the second local algorithm model is executed locally, which consumes a relatively short time, and therefore can ensure that the process of generating a target image is completed instantly. Therefore. the process of rendering the target image is insensitive to the user, and the fluency of the effect rendering process is improved.

Corresponding to the method for end-cloud collaboration-based image processing in the foregoing embodiments. FIG. 12 is a structural block diagram of an end-cloud coordination-based image processing apparatus according to an embodiment of the present disclosure. For case of description, only parts related to the embodiments of the present disclosure are shown. Referring to FIG. 12, an image processing apparatus 3 based on end-cloud collaboration includes:
a display module 31 for displaying a first preview image in response to a first operation instruction, wherein the first preview image is an image obtained by adding a first visual effect with a first precision to an original image. and the first visual effect with the first precision is obtained based on a first local algorithm model run at a terminal device:

The invoking module 32 is used for sending an algorithm invoking request to a server based on a first operation instruction, wherein the algorithm invoking request is used for invoking a first remote algorithm model executed at the server to add a first visual effect with a second precision to an original image.

A generation module 33, used for responding to a second operation instruction, and generating a target image based on a rendered image responded by a server with regard to an algorithm invoking request, wherein the rendered image is an image obtained after adding a first visual effect with a second precision to an original image, and the target image is an image used for displaying on a terminal device, and wherein the second precision is greater than the first precision.

In an embodiment of the present disclosure, after displaying a first preview image, the display module 31 is further used for displaying a second preview image in response to a third operation command for the first preview image, wherein the second preview image is an image obtained by adding a second visual effect to the first preview image, and the second visual effect is obtained based on a second local algorithm model run at a terminal device: The generation module 33 is specifically used for generating a target image based on the third operation instruction and the rendered image, wherein the target image is an image obtained after adding a first visual effect and a second visual effect with a second precision to an original image.

In an embodiment of the present disclosure, the first operation instruction indicates a target effect flag corresponding to the first visual effect: The display module 31 is specifically configured to acquire, in response to a first operation instruction, a target effect identifier corresponding to a first visual effect: determining a corresponding first local algorithm model based on a target effect identifier: and invoking the first local algorithm model to render an original image, and displaying a first preview image.

In an embodiment of the present disclosure, the first remote algorithm model is a generative antagonistic network-based image style migration model: The first local algorithm model is a light-weight model obtained by model distillation of the first remote algorithm model.

In an embodiment of the present disclosure, the third operation instruction includes an effect identifier and an effect parameter corresponding to the second visual effect: The invoking module 32 is specifically used for: sending an algorithm invoking request corresponding to the first operation instruction to the server via the first process: When the display module 31 displays the second preview image in response to the third operation command for the first preview image, the display module 31 is specifically configured to invoke, through the second process. the second local algorithm model corresponding to the effect identifier, render the first preview image based on the effect parameter, and display the second preview image.

In an embodiment of the present disclosure, the invoking module 32 is specifically configured to: generate an algorithm request parameter corresponding to a first remote algorithm model based on a first operation instruction and an original image: The method includes: based on an algorithm request parameter, sending an algorithm invoking request to a server: and after sending the algorithm invoking request to the server based on a first operation instruction, an invoking module 32 being further used for receiving a rendered image responded by the server to the algorithm invoking request, and buffering same.

In an embodiment of the present disclosure, when generating a target image based on a third operation instruction and a rendered image, the generating module 33 is specifically configured to: determine a corresponding second local algorithm model according to the third operation instruction: invoking a second local algorithm model. adding a second visual effect to a rendered image, to generate a target image.

In an embodiment of the present disclosure, the third operation instruction includes an effect identifier and an effect location: when determining the corresponding second local algorithm model according to the third operation instruction, the generating module 33 is specifically used for: determining the corresponding target local algorithm model according to the effect identifier, the target local algorithm model being used for adding a target effect corresponding to the effect identifier to the image:

When the generation module 33 invokes the second local algorithm model to add the second visual effect to the rendered image to generate the target image, the generation module 33 is specifically configured to add the target effect at an effect position based on the target local algorithm model.

In an embodiment of the present disclosure, when generating a target image based on a third operation instruction and a rendered image, the generating module 33 is specifically configured to: determine a corresponding second local algorithm model according to the third operation instruction: invoking a second local algorithm model. adding a second visual effect to an original image, to generate a first image: and splicing the first image and a rendered image to generate a target image.

In an embodiment of the present disclosure, when splicing a first image and a rendered image to generate a target image, the generation module 33 is specifically used for: acquiring a first effect region and a second effect region, wherein the first effect region is an image region where a second visual effect is located in the first image. and the second effect region is an image region where a first visual effect is located in the rendered image: Based on the first effect region and the second effect region, the first image and the rendered image are spliced to generate a target image.

In an embodiment of the present disclosure, before displaying the first preview image in response to the first operation instruction, the display module 31 is further configured to: load and display an image effect tool: in response to a tool operation instruction on an image effect tool, displaying an image acquisition interface for acquiring an original image.

The display module 31, the invoking module 32, and the generating module 33 are connected in sequence. The image processing apparatus 3 based on End-Cloud coordination provided in this embodiment can execute the technical solutions of the foregoing method embodiments, and the implementation principles and technical effects thereof are similar. No further details are provided herein.

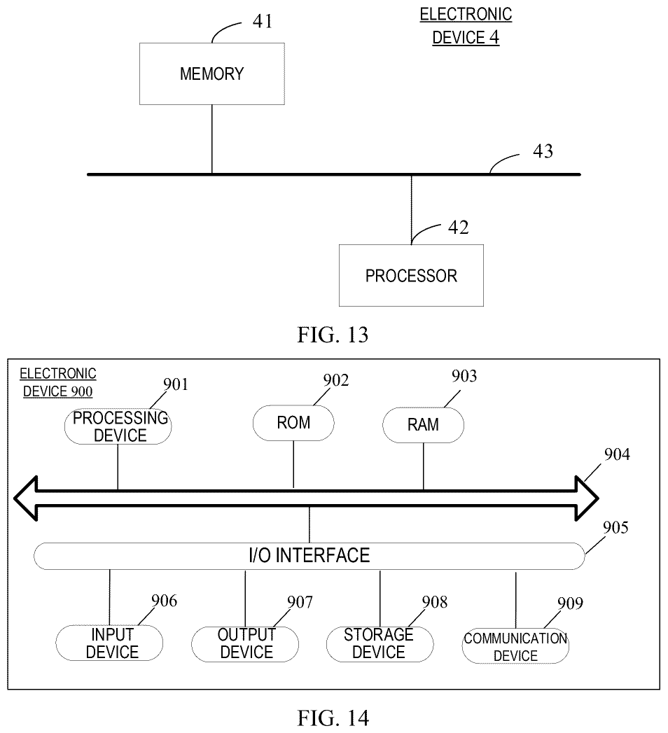

FIG. 13 is a schematic structural diagram of an electronic device according to an embodiment of the present disclosure. As shown in FIG. 13, the electronic device 4 includes:
a processor 42, and a memory 41 that is communicatively coupled with the processor 42:
the memory 41 stores a computer execution instruction;
the processor 42 executes a computer execution instruction stored in the memory 41, to implement a method for end-cloud collaboration-based image processing in the embodiments shown in FIG. 2 to FIG. 11.

Optionally: the processor 42 and the memory 41 are connected by using a bus 43.

The related descriptions can be understood with reference to the related descriptions and effects corresponding to the steps in the embodiments corresponding to FIG. 2 to FIG. 11, and are not repeated herein.

Referring to FIG. 14, it shows a schematic structural diagram of an electronic device 900 suitable for implementing an embodiment of the present disclosure. The electronic device 900 may be a terminal device or a server. The terminal device may include, but is not limited to, a mobile terminal such as a mobile phone, a laptop computer, a digital broadcast receiver, a personal digital assistant (Personal Digital Assistant. PDA), a tablet computer (Portable Android Device. PAD), a portable multimedia player (Portable Media Player. PMP), a vehicle-mounted terminal (e, g., a vehicle-mounted navigation terminal), and the like, and a fixed terminal such as a digital TV, a desktop computer, and the like. The electronic device shown in FIG. 14 is merely an example and should not bring any limitation to the functions and scope of use of the embodiments of the present disclosure.

As shown in FIG. 14, electronic device 900 may include processing means (c, g., a central processor unit. graphics processor, etc.) 901 that may perform various suitable actions and processes in accordance with a program stored in read only memory (ROM) 902 or a program loaded into random access memory (RAM) 903 from storage 908. In the RAM 903, various programs and data necessary for the operation of the electronic device 900 are also stored. The processing apparatus 901, the ROM 902, and the RAM 903 are connected to each other via a bus 904. An input/output (Input/Output. I/O) interface 905 is also connected to the bus 904.

In general, the following devices may be connected to the I/O interface 905: an input device 906 including. for example, a touch screen, a touch pad, a keyboard, a mouse, a camera, a microphone, an accelerometer, a gyroscope, or the like: an output device 907 including, for example, a liquid crystal display (LCD), a speaker, a vibrator, or the like: a storage device 908 including, for example, a magnetic tape, a hard disk, or the like; and a communication device 909. Communication device 909 may allow electronic device 900 to communicate wirelessly or wired with other devices to exchange data. While FIG. 14 illustrates an electronic device 900 with a variety of devices, it should be understood that it is not required that all of the illustrated devices be implemented or provided. More or fewer devices may alternatively be implemented or provided.

In particular, above-described processes with reference to the flowcharts can be implemented as computer software programs in accordance with embodiments of the present disclosure. For example, embodiments of the present disclosure include a computer program product comprising a computer program carried on a computer readable medium. The computer program includes a program code for executing the method as shown in the flowchart. In such an embodiment, the computer program may be downloaded and installed from the network via communications device 909, or installed from storage device 908, or installed from ROM 902. When the computer program is executed by the processing apparatus 901, above-described functions defined in the method of embodiments of the present disclosure are executed.

It should be noted that the computer readable medium in the present disclosure may be a computer readable signal medium or a computer readable storage medium, or any combination thereof. A computer-readable storage medium may be, for example, but not limited to, an electronic, magnetic, optical, electromagnetic, infrared, or semiconductor system, apparatus, or device, or any suitable combination of the foregoing. More specific examples of the computer readable storage medium may include, but are not limited to, an electrical connection having one or more wires, a portable computer diskette, a hard disk, a random access memory (RAM), a read-only memory (ROM), an erasable programmable read-only memory (Erasable Programmable Read-Only Memory), an EPROM or flash memory), an optical fiber, a portable compact disc read-only memory (CD-ROM), an optical storage device. a magnetic storage device, or any suitable combination of the foregoing. In the present disclosure, a computer readable storage medium may be any tangible medium that can contain or store a program for use by or in connection with an instruction execution system, apparatus, or device. While in the present disclosure, a computer readable signal medium may include a propagated data signal with computer readable program code embodied therein, for example, in baseband or as part of a carrier wave. Such a propagated signal may take any of a variety of forms. including, but not limited to, electro-magnetic, optical, or any suitable combination thereof. A computer readable signal medium may also be any computer readable medium that is not a computer readable storage medium and that can communicate, propagate, or transport a program for use by or in connection with an instruction execution system. apparatus, or device. Program code embodied on a computer readable medium may be transmitted using any appropriate medium, including, but not limited to, wireline, optical fiber cable, Radio Frequency (RF), etc., or any suitable combination of the foregoing.

The computer readable medium may be included in the electronic device, or may exist separately and not be installed in the electronic device.

The computer readable medium bears one or more programs, and when the one or more programs are executed by the electronic device, the electronic device is enabled to execute the method shown in the foregoing embodiments.

Computer program code for carrying out operations for aspects of the present disclosure may be written in any combination of one or more programming languages, including an object oriented programming language such as Java. Smalltalk. C++ or the like and conventional procedural programming languages, such as the ‘C’ programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the drawings illustrate the architecture, functionality, and operation of possible implementations of systems, methods and computer program products according to various embodiments of the present disclosure. In this regard, each block in the flowchart or block diagrams may represent a module. segment, or portion of code, which includes one or more executable instructions for implementing the specified logical function(s). It should also be noted that, in some alternative implementations, the functions noted in the blocks may occur out of the order noted in the drawings. For example, two blocks shown in succession may, in fact. be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units involved in the embodiments of the present disclosure may be implemented through software or hardware. The name of a unit does not constitute a limitation to the unit itself in some cases, for example, the first acquisition unit may also be described as “unit to acquire at least two internet protocol addresses”.

Above-described functions may be performed, at least in part, by one or more hardware logic components. For example, example types of hardware logic components that can be used include, without limitation. Field Programmable Gate Arrays (FPGAs). Application Specific Integrated Circuit (ASICs). Application Specific Standard Products (ASSPs). System on Chip (SOCs). Complex Programmable Logic Devices (CPLDs), etc.

In the context of this disclosure, a machine-readable medium may be tangible media that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of machine-readable storage media would include an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the foregoing.

According to a first aspect, according to one or more embodiments of the present disclosure, there is provided a method for end-cloud coordination-based image processing, the method being implemented at a terminal device. and the method includes:

in response to a first operation instruction, displaying a first preview image, wherein the first preview image is an image obtained by adding a first visual effect with a first precision to an original image, and the first visual effect with the first precision is obtained based on a first local algorithm model run at the terminal device: sending an algorithm invoking request to a server based on the first operation instruction, wherein the algorithm invoking request is used for invoking a first remote algorithm model executed at the server to add a first visual effect with a second precision to the original image, and wherein the second precision is greater than the first precision: in response to a second operation instruction, generating a target image based on a rendered image responded by the server to the algorithm invoking request, wherein the rendered image is an image obtained by adding the first visual effect with the second precision to the original image, and the target image is an image used for displaying on the terminal device.

According to one or more embodiments of the present disclosure, after displaying the first preview image. the method further includes: in response to a third operation instruction on the first preview image, displaying a second preview image, wherein the second preview image is an image obtained by adding a second visual effect to the first preview image, and the second visual effect is obtained based on a second local algorithm model executed at the terminal device: the generating a target image based on a rendered image responded by the server to the algorithm invoking request includes: generating a target image based on the third operation instruction and the rendered image, the target image being an image obtained by adding the first visual effect and the second visual effect with the second precision to the original image.

According to one or more embodiments of the present disclosure, the first operation instruction indicates a target effect identifier corresponding to the first visual effect: the in response to a first operation instruction. displaying a first preview image includes: in response to the first operation instruction, acquiring the target effect identifier corresponding to the first visual effect: determining a corresponding first local algorithm model based on the target effect identifier: invoking the first local algorithm model to render the original image, and displaying the first preview image.

According to one or more embodiments of the present disclosure, the first remote algorithm model is an image style transfer model based on a generative antagonistic network: the first local algorithm model is a light-weight model obtained by performing model distillation on the first remote algorithm model.

According to one or more embodiments of the present disclosure, the third operation instruction includes an effect identifier and an effect parameter corresponding to the second visual effect: the sending an algorithm invoking request to a server based on the first operation instruction includes: sending, through a first process, an algorithm invoking request corresponding to the first operation instruction to the server: the in response to a third operation instruction for the first preview image, displaying a second preview image includes: invoking, through a second process, a second local algorithm model corresponding to the effect identifier, rendering the first preview image based on the effect parameter, and displaying the second preview image.

According to one or more embodiments of the present disclosure, the sending an algorithm invoking request to a server based on the first operation instruction includes: generating, based on the first operation instruction and the original image, an algorithm request parameter corresponding to the first remote algorithm model: sending the algorithm invoking request to the server based on the algorithm request parameter: after sending the algorithm invoking request to a server based on the first operation instruction, the method further includes: receiving the rendered image responded by the server to the algorithm invoking request, and buffering the rendered image.

According to one or more embodiments of the present disclosure, the generating a target image based on the third operation instruction and the rendered image includes: determining a corresponding second local algorithm model based on the third operation instruction: invoking the second local algorithm model to add the second visual effect to the rendered image, to generate the target image.

According to one or more embodiments of the present disclosure, the third operation instruction includes an effect identifier and an effect location: and the determining a corresponding second local algorithm model based on the third operation instruction comprises: determining a corresponding target local algorithm model based on the effect identifier, wherein the target local algorithm model is used for adding a target effect corresponding to the effect identifier to an image: the invoking the second local algorithm model to add the second visual effect to the rendered image, to generate the target image comprises: based on the target local algorithm model, adding the target effect at the effect location.

According to one or more embodiments of the present disclosure, the generating a target image based on the third operation instruction and the rendered image includes: determining a corresponding second local algorithm model based on the third operation instruction: invoking the second local algorithm model to add the second visual effect to the original image, to generate a first image: splicing the first image and the rendered image, to generate the target image.

According to one or more embodiments of the present disclosure, the splicing the first image and the rendered image, to generate the target image includes: acquiring a first effect region and a second effect region, wherein the first effect region is an image region where a second visual effect is located in the first image, and the second effect region is an image region where a first visual effect is located in the rendered image: splicing, based on the first effect region and the second effect region, the first image and the rendered image, to generate the target image.

According to one or more embodiments of the present disclosure, before in response to a first operation instruction, displaying the first preview image, the method further includes: loading and displaying an image effect tool: in response to a tool operation instruction on the image effect tool, displaying an image acquisition interface acquiring the original image.

In a second aspect, according to one or more embodiments of the present disclosure, an image processing apparatus based on End-Cloud coordination is provided, which is applied to a terminal device, and the apparatus includes:
a display module configured to display, in response to a first operation instruction, a first preview image. wherein the first preview image is an image obtained by adding a first visual effect with a first precision to an original image, and the first visual effect with the first precision is obtained based on a first local algorithm model run at the terminal device:
an invoking module configured to send an algorithm invoking request to a server based on the first operation instruction, wherein the algorithm invoking request is used for invoking a first remote algorithm model executed at the server to add a first visual effect with a second precision to the original image, and wherein the second precision is greater than the first precision:
a generation module configured to generate, in response to a second operation instruction, a target image based on a rendered image responded by the server to the algorithm invoking request, wherein the rendered image is an image obtained by adding a first visual effect with the second precision to the original image, and the target image is an image used for displaying on the terminal device.

According to one or more embodiments of the present disclosure, after displaying a first preview image, the display module is further configured to: in response to a third operation instruction for the first preview image. display a second preview image, wherein the second preview image is an image obtained by adding a second visual effect to the first preview image, and the second visual effect is implemented based on a second local algorithm model executed on the terminal device: The generating module is specifically configured to generate a target image based on the third operation instruction and the rendered image, wherein the target image is an image obtained by adding the first visual effect and the second visual effect with the second precision to the original image.

According to one or more embodiments of the present disclosure, the first operation instruction indicates a target effect identifier corresponding to the first visual effect: the display module is specifically configured to acquire. in response to a first operation instruction, a target effect identifier corresponding to the first visual effect: determining a corresponding first local algorithm model based on the target effect identifier: invoking the first local algorithm model to render the original image, and displaying the first preview image.

According to one or more embodiments of the present disclosure, the first remote algorithm model is an image style transfer model based on a generative antagonistic network: the first local algorithm model is a light-weight model obtained by performing model distillation on the first remote algorithm model.

According to one or more embodiments of the present disclosure, the third operation instruction includes an effect identifier and an effect parameter corresponding to the second visual effect: the invoking module is specifically used for: sending, through a first process, an algorithm invoking request corresponding to the first operation instruction to the server: when the display module displays the second preview image in response to the third operation command on the first preview image, the display module is specifically configured to invoke. through the second process, a second local algorithm model corresponding to the effect identifier, render the first preview image based on the effect parameter, and display the second preview image.

According to one or more embodiments of the present disclosure, the invoking module is specifically configured to: generate, based on the first operation instruction and the original image, an algorithm request parameter corresponding to the first remote algorithm model: sending the algorithm invoking request to a server based on the algorithm request parameter: and after sending the algorithm invoking request to the server based on the first operation instruction, the invoking module is further configured to receive the rendered image responded by the server to the algorithm invoking request, and buffer the rendered image.

According to one or more embodiments of the present disclosure, when the generating module generates the target image based on the third operation instruction and the rendered image, the generating module is specifically configured to: determine a corresponding second local algorithm model based on the third operation instruction: invoking the second local algorithm model to add the second visual effect to the rendered image, to generate the target image.

According to one or more embodiments of the present disclosure, the third operation instruction includes an effect identifier and an effect location: when determining a corresponding second local algorithm model based on the third operation instruction, the generating module is specifically configured to: determine a corresponding target local algorithm model based on the effect identifier, wherein the target local algorithm model is used for adding a target effect corresponding to the effect identifier to an image.: when the generating module invokes the second local algorithm model to add the second visual effect to the rendered image to generate the target image, the generating module is specifically configured to, based on the target local algorithm model, add the target effect at the effect location.

According to one or more embodiments of the present disclosure, when the generating module generates the target image based on the third operation instruction and the rendered image, the generating module is specifically configured to: determine a corresponding second local algorithm model based on the third operation instruction: invoke the second local algorithm model to add the second visual effect to the original image, to generate a first image: splice the first image and the rendered image, to generate the target image.

According to one or more embodiments of the present disclosure, the generating module splices the first image and the rendered image, when generating the target image, specifically used for acquiring a first effect region and a second effect region, wherein the first effect region is an image region where a second visual effect is located in the first image, the second effect region being an image region where a first visual effect is located in the rendered image: splicing, based on the first effect region and the second effect region, the first image and the rendered image to generate the target image.

According to one or more embodiments of the present disclosure, before in response to the first operation command, displaying the first preview image, the display module is further configured to: load and display an image effect tool: in response to a tool operation instruction on the image effect tool, displaying an image acquisition interface for acquiring the original image.

According to a third aspect, according to one or more embodiments of the present disclosure, there is provided an electronic device, comprising: a processor and a memory communicatively coupled with the processor:
the memory stores computer execution instructions:
the processor executes the computer execution instructions stored in the memory are executed by the processor to implement the method for end-cloud collaboration-based image processing according to the foregoing first aspect and various possible designs in the first aspect.

According to a fourth aspect, according to one or more embodiments of the present disclosure, a computer readable storage medium is provided. The computer readable has computer execution instructions stored therein which, when executed by a processor, implement the method for end-cloud collaboration-based image processing according to various possible designs of the first aspect and the first aspect.

According to a fifth aspect, an embodiment of the present disclosure provides a computer program product. including a computer program, when executed by a processor, implements the method for end-cloud collaboration-based image processing according to the first aspect and various possible designs of the first aspect.

According to a sixth aspect, an embodiment of the present disclosure provides a computer program, when executed by a processor, implements the method for end-cloud collaboration-based image processing according to the first aspect and various possible designs of the first aspect.

A method for end-cloud collaboration-based image processing and an apparatus, an electronic device, a storage medium, a computer program product and a computer program are provided by embodiments of the present disclosure, displaying a first preview image by responding to a first operation instruction, wherein the first preview image is an image obtained by adding a first visual effect with a first precision to an original image, and the first visual effect with the first precision is obtained based on a first local algorithm model run at the terminal device: sending an algorithm invoking request to a server based on the first operation instruction, wherein the algorithm invoking request is used for invoking a first remote algorithm model executed at the server to add a first visual effect with a second precision to the original image, and wherein the second precision is greater than the first precision: in response to a second operation instruction, generating a target image based on a rendered image responded by the server to the algorithm invoking request, wherein the rendered image is an image obtained by adding the first visual effect with the second precision to the original image, and the target image is an image used for displaying on the terminal device. Generating and displaying the first preview image with the first visual effect with low accuracy by executing the first local algorithm locally, a purpose of showing a rendering effect for a user in advance can realized, and at the same time, synchronously sending the original image to the server to execute a corresponding first remote algorithm model, generating the rendered image which the first visual effect with high accuracy is added, and when a user determines to use the first visual effect to render the original image, when the second operation instruction is input, the effect rendering process is actually executed at the server side, therefore, the rendered image responded by the server may be obtained more quickly, and the target image for final display is generated based on the rendered image, avoiding occurrence of being stuck and forced waiting page, or reducing duration of being stuck and forced waiting page, and improving fluency and efficiency of the terminal device executing an effect rendering process.

The foregoing description is merely illustrative of the preferred embodiments of the present disclosure and of the technical principles applied thereto, as will be appreciated by those ordinary skilled in the art, The disclosure of the present disclosure is not limited to the technical solution formed by the specific combination of the described technical features, At the same time, it should also cover other technical solutions formed by any combination of the described technical features or equivalent features thereof without departing from the described disclosed concept. For example, above-described features and technical features having similar functions disclosed in the present disclosure (but not limited thereto) are replaced with each other to form a technical solution.

In addition, while operations are depicted in a particular order, this should not be understood as requiring that the operations be performed in the particular order shown or in sequential order. Multitasking and parallel processing may be advantageous in certain circumstances. Likewise, while several specific implementation details are included in above-described discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or methodological acts, it is to be understood that the subject matter defined in the appended claims is not necessarily limited to the specific features or above-described acts. Rather, the specific features and above-described acts are merely example forms of implementing the claims.

1. A method for end-cloud collaboration-based image processing, the method being implemented at a terminal device and comprising:
in response to a first operation instruction, displaying a first preview image, wherein the first preview image is an image obtained by adding a first visual effect with a first precision to an original image, and the first visual effect with the first precision is obtained based on a first local algorithm model run at the terminal device;
sending an algorithm invoking request to a server based on the first operation instruction, wherein the algorithm invoking request is used for invoking a first remote algorithm model executed at the server to add a first visual effect with a second precision to the original image, and wherein the second precision is greater than the first precision; and
in response to a second operation instruction, generating a target image based on a rendered image responded by the server to the algorithm invoking request, wherein the rendered image is an image obtained by adding the first visual effect with the second precision to the original image, and the target image is an image used for displaying on the terminal device.

2. The method of claim 1, wherein after displaying the first preview image, the method further comprises:
in response to a third operation instruction on the first preview image, displaying a second preview image, wherein the second preview image is an image obtained by adding a second visual effect to the first preview image, and the second visual effect is obtained based on a second local algorithm model executed at the terminal device;
wherein the generating a target image based on the rendered image responded by the server to the algorithm invoking request comprises:
generating a target image based on the third operation instruction and the rendered image, the target image being an image obtained by adding the first visual effect and the second visual effect with the second precision to the original image.

3. The method of claim 1, wherein the first operation instruction indicates a target effect identifier corresponding to the first visual effect;
the in response to a first operation instruction, displaying a first preview image comprises:
in response to the first operation instruction, acquiring the target effect identifier corresponding to the first visual effect;
determining a corresponding first local algorithm model based on the target effect identifier; and
invoking the first local algorithm model to render the original image, and displaying the first preview image.

4. The method of claim 1, wherein the first remote algorithm model is an image style transfer model based on a generative antagonistic network;
the first local algorithm model is a light-weight model obtained by performing model distillation on the first remote algorithm model.

5. The method of claim 2, wherein the third operation instruction comprises an effect identifier and an effect parameter corresponding to the second visual effect;
wherein the sending an algorithm invoking request to a server based on the first operation instruction comprises:
sending, through a first process, an algorithm invoking request corresponding to the first operation instruction to the server;
wherein the in response to a third operation instruction on the first preview image, displaying a second preview image comprises:
invoking, through a second process, a second local algorithm model corresponding to the effect identifier, rendering the first preview image based on the effect parameter, and displaying the second preview image.

6. The method of claim 1, wherein the sending an algorithm invoking request to a server based on the first operation instruction comprises:
generating, based on the first operation instruction and the original image, an algorithm request parameter corresponding to the first remote algorithm model; and
sending the algorithm invoking request to the server based on the algorithm request parameter;
wherein after sending the algorithm invoking request to a server based on the first operation instruction, the method further comprises:
receiving the rendered image responded by the server to the algorithm invoking request, and buffering the rendered image.

7. The method of claim 2, wherein the generating a target image based on the third operation instruction and the rendered image comprises:
determining a corresponding second local algorithm model based on the third operation instruction; and
invoking the second local algorithm model to add the second visual effect to the rendered image, to generate the target image.

8. The method of claim 7, wherein the third operation instruction comprises an effect identifier and an effect location; and the determining a corresponding second local algorithm model based on the third operation instruction comprises:
determining a corresponding target local algorithm model based on the effect identifier, wherein the target local algorithm model is used for adding a target effect corresponding to the effect identifier to an image;
wherein the invoking the second local algorithm model to add the second visual effect to the rendered image, to generate the target image comprises:
based on the target local algorithm model, adding the target effect at the effect location.

9. The method of claim 2, wherein the generating a target image based on the third operation instruction and the rendered image comprises:
determining a corresponding second local algorithm model based on the third operation instruction;
invoking the second local algorithm model to add the second visual effect to the original image, to generate a first image; and
splicing the first image and the rendered image, to generate the target image.

10. The method of claim 9, wherein the splicing the first image and the rendered image, to generate the target image comprises:
acquiring a first effect region and a second effect region, wherein the first effect region is an image region where a second visual effect is located in the first image, and the second effect region is an image region where a first visual effect is located in the rendered image; and
splicing, based on the first effect region and the second effect region, the first image and the rendered image to generate the target image.

11. The method of claim 1, wherein before in response to a first operation instruction, displaying the first preview image, the method further comprises:
loading and displaying an image effect tool; and
in response to a tool operation instruction on the image effect tool, displaying an image acquisition interface for acquiring the original image.

12. (canceled)

13. An electronic device, comprising: a processor, and a memory communicatively coupled with the processor;
the memory stores computer execution instructions;
the computer execution instructions stored in the memory are executed by the processor to implement a method for end-cloud collaboration-based image processing, the method comprises:
in response to a first operation instruction, displaying a first preview image, wherein the first preview image is an image obtained by adding a first visual effect with a first precision to an original image, and the first visual effect with the first precision is obtained based on a first local algorithm model run at the terminal device;
sending an algorithm invoking request to a server based on the first operation instruction, wherein the algorithm invoking request is used for invoking a first remote algorithm model executed at the server to add a first visual effect with a second precision to the original image, and wherein the second precision is greater than the first precision;
in response to a second operation instruction, generating a target image based on a rendered image responded by the server to the algorithm invoking request, wherein the rendered image is an image obtained by adding the first visual effect with the second precision to the original image, and the target image is an image used for displaying on the terminal device.

14. A non-transitory computer readable storage medium, wherein the non-transitory computer readable storage medium has computer execution instructions stored therein which, when executed by a processor, implement the method for end-cloud collaboration-based image processing, the method comprises:
in response to a first operation instruction, displaying a first preview image, wherein the first preview image is an image obtained by adding a first visual effect with a first precision to an original image, and the first visual effect with the first precision is obtained based on a first local algorithm model run at the terminal device;
sending an algorithm invoking request to a server based on the first operation instruction, wherein the algorithm invoking request is used for invoking a first remote algorithm model executed at the server to add a first visual effect with a second precision to the original image. and wherein the second precision is greater than the first precision;
in response to a second operation instruction, generating a target image based on a rendered image responded by the server to the algorithm invoking request, wherein the rendered image is an image obtained by adding the first visual effect with the second precision to the original image, and the target image is an image used for displaying on the terminal device.

15. (canceled)

16. (canceled)

17. The electronic device of claim 13, wherein after displaying the first preview image, the method further comprises:
in response to a third operation instruction on the first preview image, displaying a second preview image, wherein the second preview image is an image obtained by adding a second visual effect to the first preview image, and the second visual effect is obtained based on a second local algorithm model executed at the terminal device;
wherein the generating a target image based on the rendered image responded by the server to the algorithm invoking request comprises:
generating a target image based on the third operation instruction and the rendered image, the target image being an image obtained by adding the first visual effect and the second visual effect with the second precision to the original image.

18. The electronic device of claim 13, wherein the first operation instruction indicates a target effect identifier corresponding to the first visual effect;
the in response to a first operation instruction, displaying a first preview image comprises:
in response to the first operation instruction, acquiring the target effect identifier corresponding to the first visual effect;
determining a corresponding first local algorithm model based on the target effect identifier; and
invoking the first local algorithm model to render the original image, and displaying the first preview image.

19. The electronic device of claim 13, wherein the first remote algorithm model is an image style transfer model based on a generative antagonistic network;
the first local algorithm model is a light-weight model obtained by performing model distillation on the first remote algorithm model.

20. The electronic device of claim 17, wherein the third operation instruction comprises an effect identifier and an effect parameter corresponding to the second visual effect;
wherein the sending an algorithm invoking request to a server based on the first operation instruction comprises:
sending, through a first process, an algorithm invoking request corresponding to the first operation instruction to the server;
wherein the in response to a third operation instruction on the first preview image, displaying a second preview image comprises:
invoking, through a second process, a second local algorithm model corresponding to the effect identifier, rendering the first preview image based on the effect parameter, and displaying the second preview image.

21. The electronic device of claim 13, wherein the sending an algorithm invoking request to a server based on the first operation instruction comprises:
generating, based on the first operation instruction and the original image, an algorithm request parameter corresponding to the first remote algorithm model; and
sending the algorithm invoking request to the server based on the algorithm request parameter;
wherein after sending the algorithm invoking request to a server based on the first operation instruction, the method further comprises:
receiving the rendered image responded by the server to the algorithm invoking request, and buffering the rendered image.

22. The electronic device of claim 17, wherein the generating a target image based on the third operation instruction and the rendered image comprises:
determining a corresponding second local algorithm model based on the third operation instruction; and
invoking the second local algorithm model to add the second visual effect to the rendered image, to generate the target image.

23. The electronic device of claim 17, wherein the third operation instruction comprises an effect identifier and an effect location; and the determining a corresponding second local algorithm model based on the third operation instruction comprises:
determining a corresponding target local algorithm model based on the effect identifier, wherein the target local algorithm model is used for adding a target effect corresponding to the effect identifier to an image;
wherein the invoking the second local algorithm model to add the second visual effect to the rendered image, to generate the target image comprises:
based on the target local algorithm model, adding the target effect at the effect location.
